(19) United States
(12) Patent Application Publication
(10) Pub. No.: US 2003/0042121 A1
(43) Pub. Date: Mar. 6, 2003

(54) Push switch

(76) Inventors: Hiroshi Hirahata, Fukuoka (JP); Shuji Teruyama, Fukuoka (JP); Nobutaka Imai, Tokyo (JP)

Correspondence Address: WHITHAM, CURTIS & CHRISTOFFERSON, P.C., SUITE 340, 11491 SUNSET HILLS ROAD, P.O. BOX 9204, RESTON, VA, 20190, US

(21) Appl. No.: 10/218,581

(22) Filed: Aug. 15, 2002

(30) Foreign Application Priority Data
Aug. 30, 2001 (JP) P2001-262134

(51) Int. Cl. H01H 13/14

(52) U.S. Cl. 200/341

(57) ABSTRACT

In a push switch, a hemispherical click spring is always connected to a first contact electrically. When a key top is depressed, the click spring is brought into contact with a second contact so that the first contact and the second contact are electrically connected. A bottom portion of the key top is bonded to a center portion of an upper face of the click spring with an adhesive agent.

### BACKGROUND OF THE INVENTION

The present invention relates to a push switch, and relates in particular to a push switch using a hemispherical click spring.

FIG. 5 shows a related-art push switch 1 in which a hemispherical click spring 5 is mounted on a wiring board 2, while the convex face thereof is directed upward. The outer edges of the click spring 5 is electrically connected with an outer fixed contact 3 provided on the wiring board 2, and the center of the hemispherical click spring is positioned above a fixed contact 4 in the middle.

A lower end 6a of a key top 6, which is located on the upper face of the hemispherical click spring 5, contacts the center portion of the upper face of the hemispherical click spring (the center portion of the convex face), and an upper end 6b is projected upward from a hole 8 in a switch cover 7. A stopper 6c having a larger diameter than that of the upper end 6b is formed on the key top 6. When the key top 6 is pushed upward by the recovery force of the hemispherical click spring 5, the stopper 6c is brought into contact with the reverse face of the switch cover 7 to prevent the key top 6 from popping out.

When the key top 6 of the push switch 1 is depressed, the convex portion of the hemispherical click spring 5 is pushed and deformed, the center of the lower face of the hemispherical click spring 5 is brought into contact with the middle fixed contact 4, and the middle fixed contact 4 and the outer fixed contact 3 are rendered conductive by the hemispherical click spring 5.

However, since the hemispherical click spring 5 is curved, the lower end 6a of the key top 6 may slide along the upper face of the hemispherical click spring 5 and be shifted away from the center, so that the click feeling provided when the hemispherical click spring 5 is deformed is deteriorated, i.e., an inferior feeling is obtained. In order to prevent this deterioration and to obtain a consistently satisfactory click feeling, the positioning accuracy of the hemispherical click spring 5 and the assembly accuracy for the key top 6 must be improved and the properties of the hemispherical click spring 5 must be enhanced.

### SUMMARY OF THE INVENTION

It is therefore an object of the present invention to provide a push switch provided with a hemispherical click spring, wherein a consistently satisfactory click feeling can be obtained without considering a positioning accuracy of the hemispherical click spring and an assembling accuracy of a key top.

In order to achieve the above object, according to the present invention, there is provided a push switch, comprising:

a key top;

a hemispherical click spring;

a first contact, to which the click spring is always connected electrically;

a second contact, with which the click spring is brought into contact when the key top is depressed, so that the first contact and the second contact are electrically connected; and

an adhesive agent, which bonds a bottom portion of the key top with a center portion of an upper face of the click spring.

In this configuration, when the hemispherical click spring is deformed by depressing the key top, the bottom portion of the key top does not slide across the upper face of the hemispherical click spring and is not shifted away from the center, and a consistently satisfactory click feeling can be obtained. Therefore, through simplification of the design, the efficiency of the assembly can be enhanced, and not much consideration need be given to the accuracy with which the hemispherical click spring and the key top are positioned and assembled.

Here, it is preferable that the adhesive agent is a soft adhesive agent.

In this configuration, the adhesive does not crack or peel off even when the hemispherical click spring is repetitively displaced. Therefore, the consistently satisfactory table click feeling can be maintained for an extended period of time.

Preferably, a bottom face of the key top is formed with a recess, and the upper face of the hemispherical click spring is formed with a protrusion inserted into the recess.

In this configuration, the key top can be easily positioned relative to the hemispherical click spring.

In order to attain the same advantages, there is also provided a push switch, comprising:

a key top;

a hemispherical click spring;

a rod member, extended from a bottom face of the key top;

a first contact, to which the click spring is always connected electrically;

a second contact, with which the click spring is brought into contact when the key top is depressed, so that the first contact and the second contact are electrically connected; and

an adhesive agent, which bonds a lower end portion of the rod member with a center portion of an upper face of the click spring.

Here, it is preferable that the adhesive agent is a soft adhesive agent.

Preferably, a bottom face of the key top is formed with a recess, and the upper face of the hemispherical click spring is formed with a protrusion inserted into the recess.

According to the present invention, there is also provided a push switch, comprising:

a key top;

a hemispherical click spring;

a cover tape, which covers an upper face of the click spring;

a first contact, to which the click spring is always connected electrically;

a second contact, with which the click spring is brought into contact when the key top is depressed, so that the first contact and the second contact are electrically connected; and

an adhesive agent, which bonds a bottom portion of the key top with an upper face of the cover tape where corresponds to a center portion of the upper face of the click spring.

Here, it is preferable that the adhesive agent is a soft adhesive agent.

Preferably, the cover tape is made of a material softer than a material forming the click spring.

In this case, because the cover tape is composed of a soft material, a consistently satisfactory click feeling can be enhanced.

In order to attain the same advantages, there is also provided a push switch, comprising:

a key top;

a hemispherical click spring;

a rod member, extended from a bottom face of the key top;

a cover tape, which covers an upper face of the click spring;

a first contact, to which the click spring is always connected electrically;

a second contact, with which the click spring is brought into contact when the key top is depressed, so that the first contact and the second contact are electrically connected; and

an adhesive agent, which bonds a lower end portion of the rod member with an upper face of the cover tape where corresponds to a center portion of the upper face of the click spring.

Here, it is preferable that the adhesive agent is a soft adhesive agent.

Preferably, the cover tape is made of a material softer than a material forming the click spring.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a front, vertical cross-sectional view of a push switch according to a first embodiment of the present invention;

FIG. 2 is a front, vertical cross-sectional view of a push switch according to a second embodiment of the invention;

FIG. 3 is a front, vertical cross-sectional view of a push switch according to a third embodiment of the invention;

FIG. 4 is a front, vertical cross-sectional view of a push switch according to a fourth embodiment of the invention; and

FIG. 5 is a front, vertical cross-sectional view of a related-art push switch.

### DETAILED DESCRIPTION OF THE PREFERRED EMBODIMENTS

Preferred embodiments of the present invention will now be described in detail while referring to the accompanying drawings. The same reference numerals are used throughout to denote components corresponding to those for the related-art configuration, and no further explanation for them will be given.

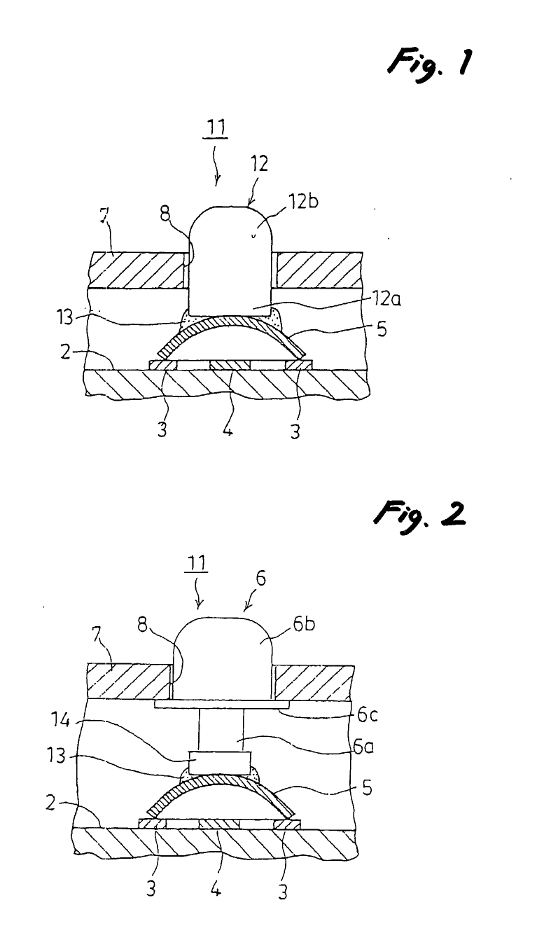

FIG. 1 is a diagram showing a push switch 11 according to a first embodiment of the invention in which a hemispherical click spring 5 is mounted on the top of fixed contacts 3 and 4 formed on a wiring substrate 2, while the convex face of the hemispherical click spring 5 is directed upward. The outer, circumferential edge of the hemispherical click spring 5 contacts the outer fixed contact 3, and the center of the hemispherical click spring 5 is positioned above the middle fixed contact 4.

A lower end 12a of a key top 12 is secured by an adhesive 13 to the center of the upper face of the hemispherical click spring 5, while an upper end 12b thereof projects upward through a hole 8 in a switch cover 7. Therefore, the center of the hemispherical click spring 5 almost exactly corresponds to the center of the key top 12, so that when the hemispherical click spring 5 is deformed by the depression of the key top 12, the lower end 12a of the key top 12 will not slide along the upper face of the hemispherical click spring 5 and will not shift away from the center. In this manner, a consistently satisfactory click feeling can be obtained.

To bond the key top 12 to the center of the upper face of the hemispherical click spring 5, a jig can be used to easily and accurately position the key top 12. However, even when eye observation alone is relied on for the positioning, and the key top 12 is merely bonded to the approximate center portion of the hemispherical click spring 5, integration of the hemispherical click spring 5 and the key top 12 can be achieved, so that the depression of the key top 12 and the inversion of the hemispherical click spring 5 together produce an extremely satisfactory click feeling. That is, for the bonding of the hemispherical click spring 5 and the key top 12, not much consideration need be given to the accuracy with which the hemispherical click spring 5 and the key top 12 are positioned and assembled, so that the efficiency of the assembly and the simplification of the design can be improved.

Since the key top 12 is bonded directly to the center of the upper face of the hemispherical click spring 5, when the key top 12 is impelled upward by the recovery force produced by the hemispherical click spring 5, the rise of the key top 12 is halted at the recovery position for the hemispherical click spring 5. Therefore, no stopper is required to prevent the key top 12 from popping out.

As the adhesive 13, a soft adhesive such as a silicon adhesive or silicon containing a silyl group is employed. And since a soft adhesive is used to bond the hemispherical click spring 5 to the key top 12, cracking or peeling is hardly to occur on the solidified adhesive even when the hemispherical click spring 5 is forced down and deformed, or repetitively deformed by operating the key top 12 frequently.

FIG. 2 is a diagram showing a push switch according to a second embodiment wherein a pushing member 14, such as an operating rod or a contact board, is secured by the adhesive 13 to the center of the upper face of the hemispherical click spring 5.

In this case, instead of the key top 12 of the first embodiment, a key top 6 having the same shape as the related-art is mounted so that its lower end 6a contacts the center of the upper face of the pushing member 14, while its upper end 6b projects upward through a hole 8 in a switch cover 7. With this arrangement, even when the distance between the wiring board 2 and the switch cover 7 is extended, a consistently satisfactory click feeling can be obtained without much consideration having to be given to the accuracy with which the hemispherical click spring 5 and the key top 6 are positioned and assembled.

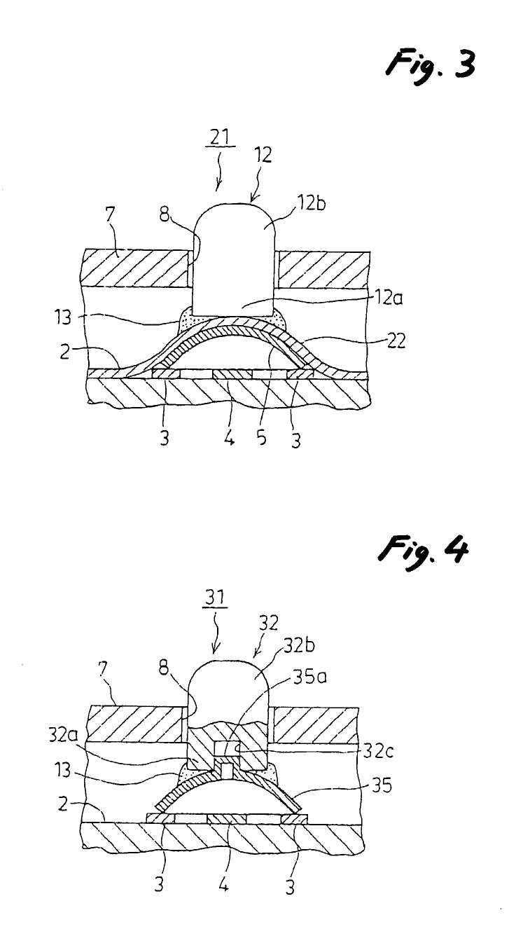

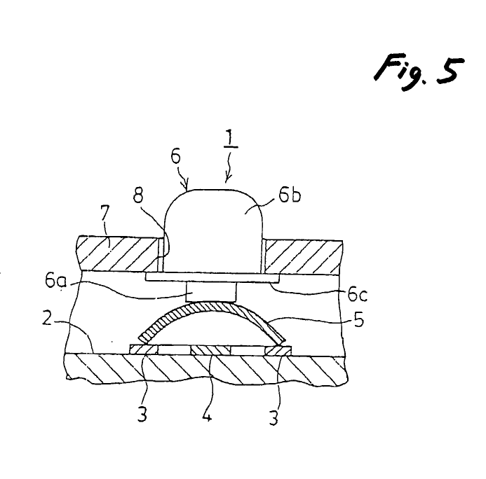

FIG. 3 is a diagram showing a push switch 21 according to a third embodiment of the invention. A hemispherical click spring 5, its convex portion extending upward, is mounted above fixed contacts 3 and 4, formed on a wiring board 2. The outer, circumferential edge of the hemispherical click spring 5 contacts the outer fixed contact 3, while its center portion is positioned above the middle fixed contact 4.

Further, a cover tape 22, arranged across the wiring board 2, is bonded to the upper face of the hemispherical click spring 5, while at the center of the upper face of the hemispherical click spring 5, the upper face of the cover tape 22 is secured by the adhesive 13 to the lower end 12a of the key top 12, the upper end 12b of which projects upward through a hole 8 in a switch cover 7. As previously described, a soft adhesive, such as a silicon adhesive or silicon containing a silyl group, is employed as the adhesive 13.

Since the key top 12 is bonded to the cover tape 22, which is arranged to serve as a switch sheet, and because the cover tape 22 is composed of a soft material, a consistently satisfactory click feeling can be obtained, as in the above embodiments, when the key top 12 is depressed and the hemispherical click spring 5 is deformed.

The configuration of this embodiment may be combined with the configuration of the second embodiment. Namely, the lower end portion of the pushing member 14 may be secured to the upper face of the cover tape 22.

FIG. 4 is a diagram showing a push switch 31 according to a fourth embodiment of the invention. A hemispherical click spring 35, its convex portion extending upward, is mounted on a fixed contact 3 and above a fixed contact 4 formed on a wiring board 2. The outer, circumferential edge of the hemispherical click spring 35 contacts the outer fixed contact 3, while its center portion is positioned above the middle fixed contact 4.

A protrusion 35a having a hollow cylindrical shape, the lower face of which is open, is formed at the center of the upper face of the hemispherical click spring 35, while at a location corresponding to that of the protrusion 35a extending upward from the hemispherical click spring 35, a recessed portion 32c is formed in a lower end 32a of a key top 32. After the recessed portion 32c is aligned with the protrusion 35a, the center of the upper face of the hemispherical click spring 35 is secured by an adhesive 13 to the lower end 32a of the key top 32. The upper end 32b of the key top 32 projects upward through a hole 8 in a switch cover 7. As previously described, a soft adhesive, such as a silicon adhesive or silicon containing a silyl group, is employed as the adhesive 13.

Since the recessed portion 32c of the key top 32 is aligned with the protrusion 35a of the hemispherical click spring 35, the center of the hemispherical click spring 35 can be exactly positioned at the center of the key top 32 without using a jig, so that these two components can be easily and accurately assembled. Therefore, as in the above embodiments, a consistently satisfactory click feeling can be obtained without much consideration having to be given to the accuracy with which the hemispherical click spring 35 and the key top 32 are positioned and assembled.

The configuration of this embodiment may be combined with the configuration of the second embodiment. Namely, a recessed portion is formed on a bottom face of the pushing member 14 so that the protrusion 35a is inserted into the recessed portion.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A push switch, comprising:
a key top;
a hemispherical click spring;
a first contact, to which the click spring is always connected electrically;
a second contact, with which the click spring is brought into contact when the key top is depressed, so that the first contact and the second contact are electrically connected; and
an adhesive agent, which bonds a bottom portion of the key top with a center portion of an upper face of the click spring.

2. The push switch as set forth in claim 1, wherein the adhesive agent is a soft adhesive agent.

3. The push switch as set forth in claim 1, wherein a bottom face of the key top is formed with a recess, and the upper face of the hemispherical click spring is formed with a protrusion inserted into the recess.

4. A push switch, comprising:
a key top;
a hemispherical click spring;
a rod member, extended from a bottom face of the key top;
a first contact, to which the click spring is always connected electrically;
a second contact, with which the click spring is brought into contact when the key top is depressed, so that the first contact and the second contact are electrically connected; and
an adhesive agent, which bonds a lower end portion of the rod member with a center portion of an upper face of the click spring.

5. The push switch as set forth in claim 4, wherein the adhesive agent is a soft adhesive agent.

6. The push switch as set forth in claim 4, wherein a lower end face of the rod member is formed with a recess, and the upper face of the click spring is formed with a protrusion inserted into the recess.

7. A push switch, comprising:
a key top;
a hemispherical click spring;
a cover tape, which covers an upper face of the click spring;
a first contact, to which the click spring is always connected electrically;
a second contact, with which the click spring is brought into contact when the key top is depressed, so that the first contact and the second contact are electrically connected; and
an adhesive agent, which bonds a bottom portion of the key top with an upper face of the cover tape where corresponds to a center portion of the upper face of the click spring.

8. The push switch as set forth in claim 7, wherein the adhesive agent is a soft adhesive agent.

9. The push switch as set forth in claim 7, wherein the cover tape is made of a material softer than a material forming the click spring.

10. A push switch, comprising:
a key top;
a hemispherical click spring;
a rod member, extended from a bottom face of the key top;
a cover tape, which covers an upper face of the click spring;
a first contact, to which the click spring is always connected electrically;
a second contact, with which the click spring is brought into contact when the key top is depressed, so that the first contact and the second contact are electrically connected; and
an adhesive agent, which bonds a lower end portion of the rod member with an upper face of the cover tape where corresponds to a center portion of the upper face of the click spring.

11. The push switch as set forth in claim 10, wherein the adhesive agent is a soft adhesive agent.

12. The push switch as set forth in claim 10, wherein the cover tape is made of a material softer than a material forming the hemispherical click spring.
